(19) United States
(12) Patent Application Publication
(10) Pub. No.: US 2004/0023410 A1
(43) Pub. Date: Feb. 5, 2004

(54) Method and apparatus for continuous sample deposition on sample support plates for liquid chromatography-matrix-assisted laser desorption/ionization mass spectrometry

(76) Inventor: Catherine Stacey, Boxborough, MA (US)

Correspondence Address: Ward & Olivo, 708 Third Ave, New York, NY, 10017, US

(21) Appl. No.: 10/213,144

(22) Filed: Aug. 5, 2002

(51) Int. Cl. G01N 24/00

(52) U.S. Cl. 436/173; 436/149; 436/161; 422/82.01; 204/451; 204/601; 250/281; 250/282

(57) ABSTRACT

Disclosed is a method and apparatus for matrix-assisted laser desorption ionization (MALDI), whereby the components of a sample separated by the column of a chromatographic separation device such as a liquid chromatograph or capillary electrophoresis are eluted and deposited on a sample support plate in a continuous track which both concentrates the sample components and preserves the fidelity of the separation. Analysis by MALDI is thus decoupled from the requirements of the separation and deposition and is performed by moving the continuous track relative to a focused laser beam in order to ionize the sample. The deposition capillary is in relative motion to the sample support plate with a speed of motion compatible with the liquid flow rate. In order to prevent the liquid sample from spreading across the sample support plate and to focus it to a pre-defined narrow region, the deposition of the sample is made along a hydrophilic anchor track of a well-defined width of less than 1 mm on the surface of the sample plate.

### TECHNICAL FIELD OF THE INVENTION

The invention relates to a method and device for matrix-assisted laser desorption ionization (MALDI), whereby the components of a sample separated by the column of a chromatographic separation device such as a liquid chromatograph or a capillary electrophoresis device are eluted and deposited on a sample support plate in a continuous track which both concentrates the sample components and preserves the fidelity of the separation. Analysis of the sample by MALDI is thus decoupled from the requirements of the separation and deposition from the chromatographic device.

Analysis is then performed by moving the continuous track of sample relative to a focused laser beam in order to ionize the sample. The rate at which the track is moved may be determined by the analysis information required and may be continually adjusted during the analysis to optimize the information content.

### BACKGROUND OF THE INVENTION

It has become standard practice to use mass spectrometry with ionization by matrix-assisted laser desorption/ionization (MALDI) for the analysis of large molecules, such as biomolecules. Typically, time-of-flight mass spectrometers (TOF-MS) are used for this purpose, although ion cyclotron resonance spectrometers, including Fourier Transform ion cyclotron resonance (FT-ICR) spectrometers as well as high-frequency quadrupole ion trap mass spectrometers may be used. In MALDI analyses, the large molecules of the analyte on the sample support are embedded in a layer of tiny crystals of a low-molecular weight matrix substance. The laser light pulse causes a small quantity of matrix substance to evaporate virtually instantaneously. The vapor cloud initially takes up virtually the same space as the solid substance, that is, it is subjected to high pressure. The large analyte molecules are also contained in the initially tiny vapor cloud. In forming the vapor cloud a small fraction of the molecules, that is both the matrix and the large analyte molecules, are ionized. Then the vapor cloud expands into the ambient vacuum in an adiabatic and isentropic process in a manner similar to an explosion. As long as there is still contact between the molecules during expansion of the vapor cloud, the large analyte molecules, having lower ionization energies, are ionized by ion molecule reactions at the expense of the smaller matrix ions. During adiabatic expansion, the vapor cloud expanding into the vacuum accelerates not only the molecules and ions of the matrix substance but also, due to viscous friction, the molecules and the ions of the analyte. When the cloud expands in a space which is free of electric fields, the ions reach average velocities of approximately 700 meters per second—the velocities are largely independent of the mass of the ions but they have a large velocity spread, which extends from about 200 to 2,000 meters per second. It may be assumed that the neutral molecules also have these velocities. The ions are then analyzed by the spectrometer.

In conventional MALDI, the biomolecules to be analyzed are in an aqueous solution, which will be referred to herein as the “analyte” or “analytes”. The analyte samples are placed on a sample support in the form of small drops of a solution, the drops drying very quickly and leaving a sample spot suitable for MALDI. Typically, a matrix substance is added to the solution for the MALDI process and the sample substances are encased in the crystals when the matrix substance crystallizes while drying. However, other methods have also become known by which the sample substances are applied to a matrix layer which has been applied first and is already dry. The matrix substance chosen for a given MALDI analysis is dependent upon the type of biomolecules to be analyzed—over a hundred different matrix substances are presently known. The purpose of the matrix substance in the analysis is to separate the sample molecules from each other, bond them to the sample support, transform them into the gas phase during laser desorption without destroying the biomolecules and if possible without attachment of the matrix molecules, and finally to ionize them. Typically, the analyte molecules are incorporated in some form into the usually crystalline matrix substances during crystallization or at least into the boundary-surfaces between the small crystals. The number of samples on a sample support is mostly limited today by the long time required for loading of the samples on the support and by the perishability of the samples during this period of time. If about 40,000 analysis samples must be applied in sequence to a single sample support, and the application of each sample lasts only two seconds (although the transfer pipette can hardly be properly cleaned during this time), the entire loading process then lasts already more than 22 hours. For many MALDI methods, matrix substances are used which oxidize or hydrolize when exposed for long periods to wet air and thereby lose their effectiveness for the MALDI process. Also, the biomolecular samples are often unstable, and sometimes must be stored cooled in solution and cannot be exposed for hours to laboratory air and heat.

A variety of methods for applying the sample and matrix to a sample plate are known. For example, a simple method includes pipetting a droplet of solution with sample and matrix onto a clean, metal sample support plate. After the droplet of solution dries, the spot of sample consists of small matrix crystals spread over the formerly wet area, whereby generally there is no uniform coating of the wetted area. In aqueous solutions, most of the small crystals of the matrix generally begin to grow at the margin of the wet area on the metal plate and grow toward the center. Often, long crystals are formed in a radial configuration, which easily peel off of the support plate in a direction toward the center of the sample spot. Thus, the center of the sample spot is frequently empty or covered with fine small crystals which are not usable for MALDI ionization. That is, the analyte molecules are irregularly distributed in the sample spot causing the ion yield and mass resolution to fluctuate from site to site.

Another known method includes the creation of a very thin layer of crystals on the surface before applying the aqueous analyte solutions, for example, by applying a solution of matrix substance in acetone. This would typically be used for matrix substances which dissolve very poorly or not at all in water, such as á-cyano-4-hydroxycinnamic acid, and has been found successful for peptides (see O. Vorm et al., J. Am. Soc. Mass Spectrum., 5, [1994], 955). In particular, the coating provides site-independent sensitivity in the sample spots. Unfortunately, this type of homogenous preparation cannot be used for water soluble matrices, such as for oligonucleotides. Furthermore, this matrix substance also demonstrates the edge effects described above.

It has been found that even when applying very small sample spots of reproducible sensitivity, it is extremely difficult to precisely determine the coordinates for the sample spots in the mass spectrometer, especially for a high sample throughput. It is therefore extremely desirable to know the location of the sample as exactly as possible before laser desorption and analysis. To achieve high sample throughput, automation of all analysis steps, including the preparation of the samples, is necessary.

Techniques for combining liquid-phase separations with deposition to an analysis sample target and MALDI analysis are presently quite limited due to the practical difficulties of removing the liquid from the samples prior to analysis.

Previous methods for deposition of eluates from separation instruments onto a sample support plate for MALDI mass spectrometry (MS) analysis allowed for only the deposition of discrete samples in small droplets. Deposition from a flowing stream containing separated chemical components was made by breaking the eluate stream into time or volume resolved droplets. Each droplet was separately deposited onto discrete contiguous regions of a sample support plate for later analysis. Thus, the correlation of the position of individual analysis regions to a time point in the chromatographic separation was possible. However, many of the “sample spots” may contain no components of interest and other sample spots may contain unresolved mixtures of components.

Continuous deposition of a liquid in a narrow track on a surface may be accomplished by continuously pumping the liquid through a tube with a narrow diameter outlet and drawing the tube across a flat surface or by moving the surface under the stationary tube. The resulting track of liquid will tend to disperse across the surface and exceed the deposited width. Any separated chemical components will also diffuse through the liquid volume and mix together. After the liquid has dried, measurement of the track by MALDI will be complicated by the diffusion of the samples across the increased track width and along the length, with a resulting loss of sensitivity.

One solution has been to develop methods to cause the deposited liquid to dry more quickly, before dispersion and diffusion processes take effect. Such method teaches to deposit the liquid within a low-pressure region, causing the eluate to evaporate more quickly. For example, Karger et al. EP 0 986 746 (Karger) discloses a method in which a continuous stream of liquid sample is deposited from a flowing sample onto a moving target surface within the vacuum region of a mass spectrometer. According to Karger, this allows the liquid to evaporate at room temperature. The diameter of the track of sample is controlled by limiting the liquid flow to ensure that the sample dries in a narrow track of about 40-60 micrometers (um). The deposited track of sample is placed on the surface of a moving wheel within the vacuum and analysis takes place immediately at another point along surface. However, there are several problems with this approach. For instance, the deposition and analysis speed are required to be identical, while continuously moving components within the vacuum region of a mass analyzer are prone to problems caused by evaporation of lubricants on the moving parts and by contamination of the sample with the lubricants.

Another such method, disclosed in Prevost et al. U.S. Pat. No. 5,772,964 (Prevost), uses a combination of heat and gas to dry down the liquid at atmospheric pressure, so that only the involatile components of the liquid contact the target surface. For example, Prevost describes heating a 20 centimeter (cm) long capillary through which liquid flows towards a moving collection surface. A sheath gas is then directed around the capillary toward the collection surface so that the liquid is exposed to the sheath gas immediately after emerging from the outlet end of the capillary. The liquid is heated as it passes through the capillary and the sheath gas nebulizes the heated liquid as it sprays onto the collection surface. The heat and gas thus evaporate the liquid so a dried material deposits in a continuous track on the collection surface. However, this approach typically results in a wide sample track (i.e., of 1 millimeter (mm) or more in width). Also, heating the liquid may cause some degradation of heat-sensitive sample such as biological molecules.

Yet another non-continuous method of depositing and drying liquid samples for MALDI analysis is taught by Schurenberg el al. U.S. Pat. No. 6,287,872 (Schurenberg). Here, a method of making pre-structured hydrophilic anchors on hydrophobic target surfaces is disclosed. According this method, multiple individual droplets of less than one microliter in volume are concentrated onto hydrophilic anchor areas on a target plate and then analyzed in sequence. To accomplish this, the method consists of making the surface of the sample support plate extremely hydrophobic, whereby a favorable structure of MALDI matrix crystals is generated during drying. Using very small, hydrophilic anchor areas or spots for the sample droplets on the hydrophobic surface, the sample droplets can be precisely located on the sample support plates. As the sample droplets are pipetted thereon, they are attracted to the hydrophilic anchor spots. However, this method does not result in a continuous track of sample to be used in the MALDI analysis.

A hydrophobic surface as used herein is an unwettable and liquid-repellant surface for the particular liquid sample used, even if the liquid is not an aqueous solution. For instance, in the case of an oily sample solution, a lipophobic surface should be used. Normally, however, the biomolecules dissolve best in water, sometimes with the addition of organic, water-soluble solvents, and hence a hydrophobic surface is used. Correspondingly, a hydrophilic surface as used herein is an easily wettable surface for the type of sample liquid used, even if the sample is not an aqueous solution.

To maintain hydrophobic surfaces on the sample support, the entire sample support can be produced from a hydrophobic material, for example TEFLON, which is both hydrophobic and lipophobic. However, it is necessary that the surface defines a constant electrical potential (for example by imbedding with graphite), since the MALDI process requires on the one hand a homogenous electrical field for uniform acceleration of the formed ion and, on the other hand, a dissipation of charges, the polarity of which opposes that of the ions formed. A pure graphite surface is also extremely hydrophobic.

It is certainly practical, for reasons of simple manufacture, to use sample support plates of metal or metallized plastic, and to make the surface hydrophobic. This can be done, for example, using a hydrophobic lacquer, or also by gluing on a thin, hydrophobic film, for example of TEFLON. However, it is even more practical to make the metal surface hydrophobic using a monomolecular chemical change, since a certain electrical conductivity, even if highly resistant, is then maintained. Such hydrophobing of a metal surface is well know. An additional advantage of a surface prepared in this way also lies in the fact that metal and alkali ions can no longer be solved from the metal surface by the acidic matrix solutions and later deposited during the MALDI process as adducts to the biomolecule ions.

The hydrophilic anchor for the liquid sample can be created in many ways. One example includes covering the required anchor areas with a washable or hydrophilic lacquer before hydrophobing the residual area. To create the desired track pattern, the covering lacquer can be continuously deposited using any of a number of known chemical deposition techniques. After hydrophobing, the lacquer track can be simply washed away, insofar as they do not already form sufficient a good hydrophilic anchor as such. The washed anchor can also be made especially hydrophilic using special hydrophilization agents. Such hydrophilic lacquer track can however also be imprinted subsequently onto the hydrophobic surface.

Another technique for creating the hydrophilic anchor includes a very simple process of destruction of the hydrophobic layer. This can occur by imprinting, chemically changing or enzymatically disintegrating substance solutions, by destruction using glowing hot burning tips, or also by ablation of surface material, for example using spark erosion or laser bombardment. Because the hydrophilic anchor areas may easily become coated with hydrophobic molecules from the ambient air with longer storage, it may be practical to coat the hydrophilic anchors right after their production with a thin crystal layer of MALDI matrix substance.

Accordingly, as shown in FIG. 1, a hydrophilic surface 4 of a sample plate is well suited for precise deposition of a liquid sample. That is, if globule 6 contacts hydrophilic surface 4 on sample support plate 2, the liquid sample in the eluate globule 6 will be attracted, or anchored, to that hydrophilic surface 4 and have a relatively large wetting angle 8 (i.e., greater than 90°). Globule 6 on hydrophilic surface 4 tend to spread out over such surface in a thin layer. As such, however, the chemical components in the liquid sample will disperse throughout globule 6.

Conversely, as shown in FIG. 2, a hydrophobic surface 10 is undesirable for precise such deposition of a liquid sample onto sample plate 2. In other words, liquid surface tension prevents eluate globule 6 from spreading or dispensing on a particular location of hydrophobic surface 10, resulting in a relatively small wetting angle 12 (i.e., less than 90°). Consequently, globule 6 will tend to roll around on surface 10 as it dries, so that the resulting dried spot will be of a non-uniform shape in an undefined position. It is particularly undesirable to use such a surface for a continuous deposition process such as here because any resulting track of liquid sample will not dry in a well defined pattern having a desired deposition width. Also, any separated chemical components may also then diffuse through the liquid sample volume and mix together. Once the liquid sample dries, MALDI analysis will be complicated by both the undefined dried sample and the diffusion of the samples across the increased track width and along the length, resulting in a loss of sensitivity.

It is therefore desired that a compromise be reached between the undefined position of using a hydrophobic surface (as shown in FIG. 2) and the dispersion of the chemical components when using a hydrophilic surface (as shown in FIG. 1). The present invention achieves such a compromise by having a small hydrophilic region within or on a hydrophobic surface. Specifically, the invention uses a narrow hydrophilic track on a smaple plate having a hydrophobic surface. Providing some region of the globule, during deposition, contacts that hydrophilic region, as the globule dries it will “roll” off of the hydrophobic surface and contract toward the hydrophilic region or track. Thus, the hydrophilic region will serve as an “anchor” to prevent the globule from freely rolling around as it dries.

In light of the ever increasing need for higher throughput in analytical instruments, in particular mass spectrometers, a need readily exists for a means and method for improving the sample preparation to allow for complete automation of the analysis process without sacrificing sensitivity or resolution. The present invention resolves this need.

### SUMMARY OF THE INVENTION

It is a basic idea of the invention to provide a method and device for preparing a MALDI sample plate with a continuous track of liquid sample. Specifically, a continuously flowing liquid sample is deposited from a deposition capillary onto a continuous track formed on a sample support plate. According to the preferred embodiment of the invention, the deposition capillary is in a relative motion to the sample support plate with a speed of motion compatible with the liquid flow rate exiting the capillary. In order to prevent the liquid sample from rolling around on or spreading too widely across a hydrophobic surface of a sample support plate but rather focus the liquid sample to a pre-defined narrow track or region, the sample support plate further comprises a continuous hydrophilic anchor track of a well-defined width (e.g., less than 1 millimeter (mm)). During deposition, the liquid sample exiting the capillary is deposited in or on this hydrophilic anchor track as the capillary is moved relative to the sample support plate in a manner that mimics or follows the shape or pattern (e.g., spiral, folded, etc.) of the anchor track.

According to the invention, the sample support plates are produced with one or more continuous convolved or spiral hydrophilic anchor tracks of the required width. Of course, other patterns may be used for the continuous anchor tracks. The shape of the continuous track is created in a reproducible manner so that each plate has a predetermined track position for programmed deposition and analysis. An electrically conductive plate may be treated to create a hydrophobic surface, with a hydrophilic region created by either exposing the underlying hydrophilic base material of the sample support plate by chemical or mechanical methods or by overlaying a hydrophilic region on the hydrophobic surface. Other techniques may also be used. The shape of the continuous track is preferably designed to make the most use of the area on the surface of the sample support plate, while maintaining a minimum distance between adjacent tracks.

In practice, a MALDI matrix dissolved in a liquid solution may be deposited on the hydrophilic anchor tracks from a separate narrow diameter hollow tube or together with the sample through the sample deposition capillary. Alternatively, the MALDI matrix may be separately deposited and desolvated at some time interval prior to the addition of the samples to the hydrophilic tracks. The MALDI matrix may be co-added to the sample solution by pumping a solution of matrix from a separate pump through a mixing-T prior to the deposition capillary or to a second deposition capillary that runs immediately before or behind the first deposition capillary.

The liquid eluate then emerges from the deposition capillary and is deposited onto the surface of the sample support plate in the form of a droplet. Due to the liquid surface tension between the surface and droplet, the eluate droplet will sit on (e.g., in the form of a ball) the hydrophobic surface of the sample support plate with a relatively small wetting angle (i.e., less than 90°) (as seen in FIG. 1). On the other hand, if the droplet contacts a hydrophilic, or easily wettable, region of the sample support plate, the liquid will have a relatively large wetting angle (i.e., greater than 90°) and be attracted to (or anchored to) that region (as shown in FIG. 2).

During liquid deposition, the droplet is attached to both the column of liquid eluate emerging from the deposition capillary and the hydrophilic region of the sample support plate and will have a characteristic shape. Hereinafter, the droplet of liquid eluate will be referred to as the “globule”. As the deposition capillary moves relative to the sample support plate (or vice versa) the globule forms an elongated teardrop shape from the deposition capillary to the sample support plate surface. The globule will maintain a certain dimension from the addition of fresh liquid eluate from the deposition capillary at one end of the globule that counteracts any evaporation of the liquid over the surface of the globule. At the end of the globule furthest from the deposition capillary (i.e., at the sample plate surface), the continual evaporation process will cause the liquid eluate to contract to the hydrophilic anchor track. As the globule rapidly shrinks, the rate of contraction towards the track exceeds the rate of dispersion of sample components through the liquid volume and preserves the fidelity of the chromatographic separation. The narrow, concentrated track of liquid attached to the hydrophilic track continues to evaporate, until only the MALDI matrix and sample remains. The result of the process is a narrow band of solvent-free MALDI matrix and sample deposited from a continuous liquid eluate. This narrow band has a well-defined position along the hydrophilic track and the sample is concentrated to the track region from a larger liquid volume.

Several considerations must be made for a continuous deposition and concentration of a liquid sample on a sample plate with a predefined hydrophilic anchor track, providing that a part of the deposited liquid is overlapping with the hydrophilic anchor track during the deposition. First, the deposited liquid globule has certain size restrictions. That is, the globule should have a radius not exceeding the distance between adjacent tracks to prevent the contamination of an adjacent track with the sample being deposited. In addition, the globule should not be so large as to cause it to spread along the length of the hydrophilic track or to cause different components from the sample, separated by the chromatographic separation, to become mixed in the liquid volume of the globule.

Second, the globule must shrink by evaporation of the liquid towards the hydrophilic track at a rate that matches or exceeds the flow rate of liquid into the globule from the deposition capillary. There are three important parameters to ensure the rapid shrinkage of the globule: (1) the liquid flow rate out of the deposition capillary; (2) the speed of the motion of the deposition capillary relative to the sample support plate (or vice versa); and (3) the shrinking rate of the deposit while the solvent evaporates. First, the liquid flow rate is set by the device (e.g., syringe pump, HPLC, CE, etc.) that provides the liquid sample. Second, the speed of the deposition capillary relative to the sample support plate (or vice versa) must be adjusted to ensure that, for given conditions of solvents, flow rates, temperature and pressure, the liquid globule has a constant dimension and the deposited liquid evaporates in a short time. Third, the shrinking rate of the deposited sample is a function of the volatility of the solvent (or solvent mixture) at the temperature (especially the temperature of the target surface) and pressure in the vicinity of the deposition area, which can be controlled or set to a certain value.

The samples deposited on the sample support plate are preferably analyzed by MALDI mass spectrometry, although the invention may be applied to other laser desorption and ionization techniques. For laser desorption, the laser beam is focused on the sample and matrix that have been concentrated onto the predefined position of the hydrophilic anchor track. In order to analyze the complete sample deposited on the plate, the sample has to be frequently or continuously desorbed along the deposited sample track. Desorption is accomplished by a relative motion of the sample support plate and the repetitive firing of the focused laser beam. The motion of the sample support plate is performed using a planar positioner (an x-y positioner for Cartesian motion or an r-φ positioner for curved or circular motion). Because the sample is precisely located on a predefined anchor track, the laser beam can be accurately directed to always hit the sample.

The repetition rate of the laser shots and the speed of motion of the sample support plate are controlled so that the desired number of mass analysis measurements are recorded along the length of the sample track. By monitoring the ions resulting from each acquired measurement, the speed of motion of the sample support plate may be altered with a feedback mechanism. More measurements over a small region of the track may improve sensitivity of low intensity peaks from the chromatographic separation. Fewer measurements will avoid spending analysis time on regions of the chromatographic separation that are not of interest or contain no components. The speed of motion of the sample support plate could also be slowed or stopped to acquire fragmentation spectra or to pre-accumulate ions in a multipole ion guide or Paul trap prior to analysis.

Because each position on the track relates back to a chromatographic retention time, each measurement may be marked with a position or time stamp. Many measurements may be acquired into a single dataset, which resembles the more common liquid chromatography/mass spectrometry (LC/MS) and gas chromatography/mass spectrometry (GC/MS) data sets acquired on-line with other ionization methods such as electron impact (EI) and electrospray (ESI). Typical data processing methods for LC/MS and GC/MS datasets then apply, such as extraction of selected ion current chromatograms and averaging of spectra across a chromatographic peak.

### OBJECTS OF THE INVENTION

It is therefore an object of the invention to provide a sample support plate that enables precise sample preparations and allows for automation of the mass spectrometric MALDI analyses of large biomolecules, for example, forming a precise and well defined continuous track of sample in order to achieve reproducible ionization yield. The track of sample should be patterned in a narrow but well defined manner. Thus, the invention provides a method and apparatus for the continuous deposition of a liquid sample onto a sample plate for use in the mass spectrometric MALDI analysis.

It is therefore a further basic idea of the invention to provide the surface of the sample support with a very small continuous hydrophilic anchor region, such as a track, on a hydrophobic surface to attract the liquid sample during drying to form a continuous sample for analysis.

It is another object of the present invention to provide an improved method of mass analysis whereby the intensity peaks from sensitivity of low intensity peaks from chromatographic separation is improved by allowing an increased number of measurements over a small region of the track of sample being analyzed.

Yet another object of the present invention is to provide a method whereby analysis time on regions of the chromatographic separation that are not of interest or contain no components is minimized by allowing fewer measurements.

Still another object of the present invention is to allow the slowing or stopping of the speed of motion of the sample support plate during analysis to acquire fragmentation spectra or to preaccumulate ions in a multipole ion guide or Paul trap prior to analysis.

Yet another object of the present invention is to allow marking of each measurement with a position or time stamp as it relates back to a chromatographic retention time.

It is another object of the present invention to acquire numerous measurements into a single dataset, resembling the more common liquid chromatography/mass spectrometry (LC/MS) and gas chromatography/mass spectrometry (GC/MS) data sets acquired on-line with other ionization methods such as electron impact (EI) and electrospray (ESI).

Still another object of the present invention is to apply typical data processing methods for LC/MS and GC/MS datasets, such as extraction of selected ion current chromatograms and averaging of spectra across a chromatographic peak.

Yet another object of the present invention is to improve MALDI efficiency by reducing the occurrence of “sample spots” that contain no components of interest and other sample spots that contain unresolved mixtures of components.

It is yet another object of the present invention to provide an apparatus for the continuous desorption and analysis of a MALDI sample deposited on a sample plate.

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 depicts a side view of a droplet (e.g., of liquid eluate) placed on a hydrophilic surface thereby demonstrating a relatively large resulting wetting angle.

FIG. 2 depicts a side view of a droplet (e.g., of liquid eluate) placed on a hydrophobic surface thereby demonstrating a relatively small resulting wetting angle.

FIG. 3 depicts a side view of a globule of a liquid eluate as it exits from a deposition capillary and is deposited onto a hydrophilic surface of a sample support plate in accordance with the invention.

FIG. 4 shows the preferred embodiment of a sample support plate in accordance with the invention, wherein the sample support plate has a continuous spiral hydrophilic anchor track.

FIG. 5 shows an alternate embodiment of a sample support plate in accordance with the invention, wherein the sample support plate has a continuous folded or convoluted hydrophilic anchor track.

FIG. 6A shows a perspective view of the deposition of a liquid sample globule eluate emerging from the deposition capillary onto a portion of the sample support plate shown in FIG. 4 (i.e., with a curved or spiral track), including the curvilinear movement of either the deposition capillary or the sample support plate to deposit the sample along the entire hydrophilic track and the drying and contracting of the globule to the hydrophilic anchor track.

FIG. 6B shows a transparent view of the deposition of a liquid sample globule eluate of FIG. 6A, further depicting the size and shape of the globule eluate as it is deposited onto the hydrophilic track on the sample plate.

FIG. 7A shows a perspective view of the deposition of a liquid sample globule eluate emerging from the deposition capillary onto a straight portion of the sample support plate shown in FIG. 5 (i.e., with a folded or convoluted track), including the lateral movement of either the deposition capillary or the sample support plate to deposit the sample along the entire hydrophilic track and the drying and contracting of the globule to the hydrophilic anchor track.

FIG. 7B shows a transparent view of the deposition of a liquid sample globule eluate of FIG. 7A, further depicting the size and shape of the globule eluate as it is deposited onto the hydrophilic track on the sample plate.

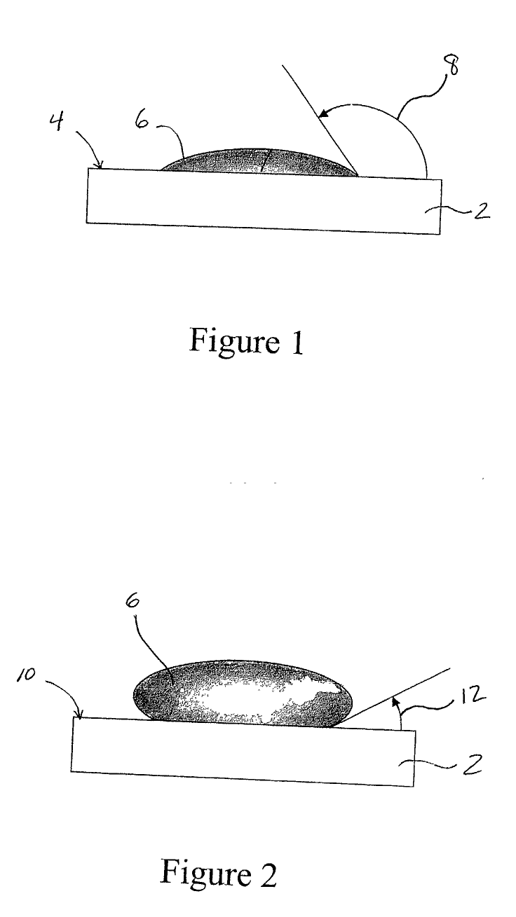

### DETAILED DESCRIPTION OF THE PREFERRED EMBODIMENT

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of a preferred embodiment (as well as some alternative embodiments) of the present invention.

According to the preferred embodiment of the invention, a method and apparatus for preparing a MALDI sample plate having a continuous track of liquid sample is disclosed. In particular, the preferred embodiment of the invention comprises a sample plate substantially comprising a hydrophobic surface with a narrow track or region of a hydrophilic material or substance having a well-defined width (e.g., less than 1 mm). A continuously flowing liquid sample is then deposited from, for example, a deposition capillary onto the continuous hydrophilic anchor track on the sample support plate. Generally, this is accomplished by moving the deposition capillary relative to the sample support plate (or vice versa) with a speed of motion comparable with the liquid flow rate exiting the deposition capillary, such that the liquid sample exiting the deposition capillary is deposited directly onto this hydrophilic anchor track, so that it concentrates, dries and anchors to the hydrophilic track. Preferably, the sample support plates are configured with one or more continuous spiral, convolved, etc., hydrophilic anchor tracks having a well-defined narrow width.

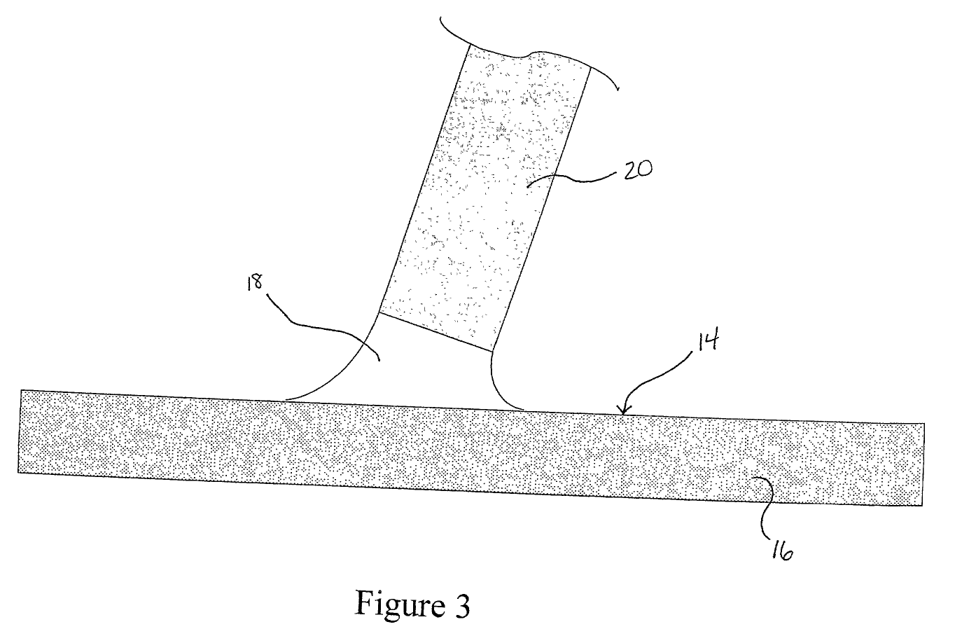

Referring first to FIG. 3, shown is a side view of a globule eluate of liquid sample 18 as it exits from deposition capillary 20 and is deposited onto sample support plate 16. In accordance with the preferred embodiment of the invention, deposition of liquid sample 18 is performed using deposition capillary 20 to deposit the liquid sample onto sample support plate from a sample supply (not shown), such as a chromatographic separation device, etc. As shown, an eluate globule of liquid sample 18 emerges from deposition capillary 20 and is deposited onto surface 14 of sample support plate 16. Deposition capillary 20 is preferably a narrow diameter hollow tube that is positioned very close to (e.g., ˜0.1 mm) sample support plate surface 14. According to the preferred embodiment of the invention, the continuously flowing liquid sample comprises water and polar organic solvents into which the samples to be analyzed are dissolved. Of course, other liquid compositions may be used as known to persons of skill in the art. The eluate may contain additional salts, buffers, bases and acids at low concentrations. In addition, the liquid may be an eluate from a separation device, e.g. a high performance liquid chromatograph (HPLC) or a capillary electrophoresis (CE) instrument, containing a number of separated components.

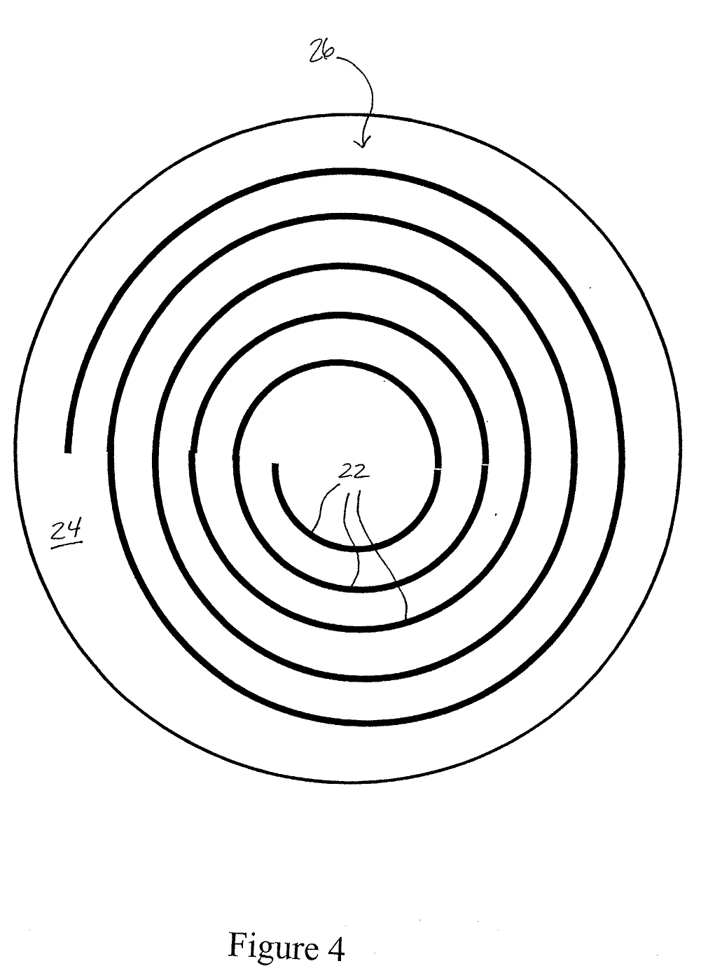

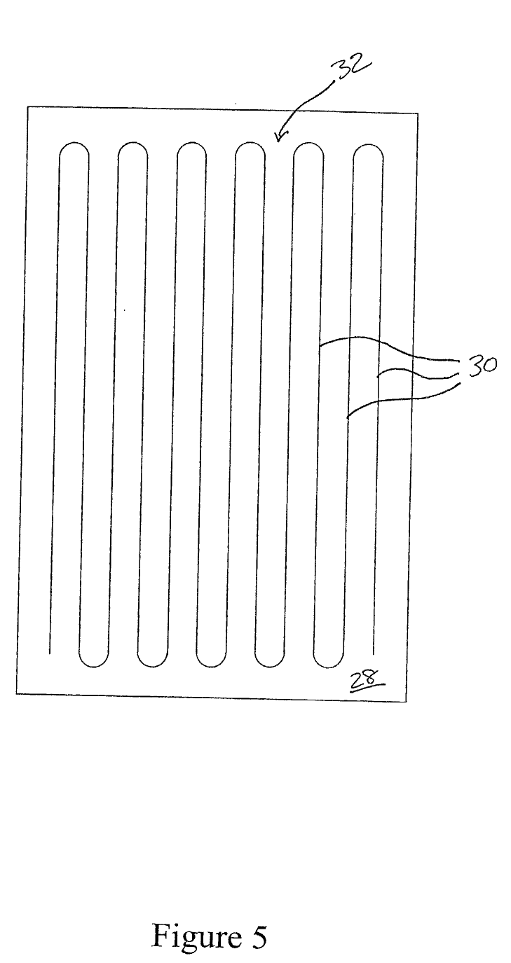

In accordance with the invention, the hydrophilic track on the hydrophobic surface of the sample plate may take any of a number of shapes, patterns or designs. Referring to FIG. 4, shown is a top plan view of the preferred embodiment of a sample support plate 24 for use in accordance with the invention. Specifically, sample support plate 24 comprises a predominantly hydrophobic surface 26, with a narrow and continuous track 22 of a hydrophilic material or substance patterned in a curved or spiral manner. Such a design or pattern is desirable because it provides a smooth, easy to follow track for deposition and desorption. Additionally, such a spiral design enables use of a maximum portion of sample support plate 24 while maintaining a certain minimum distance between any two portions of track 22. An alternative design or pattern for a hydrophilic anchor track is shown in FIG. 5. In particular, shown here is sample support plate 28, again having a predominantly hydrophobic surface 32, but rather having a continuous convolved or folded track 30 of a hydrophilic material. In both embodiments (i.e., FIGS. 4 and 5), the hydrophilic tracks 22, 30 are of a predefined width, preferably less than about 1 mm. Optionally, it may be desirable to have more than one distinct, continuous track on each sample support plate, for example, to analyze different samples from a single plate. Also, other track widths may be used depending upon a number of factors, including but not limited to the particular sample to be analyzed, the specific analysis technique to be used, etc. Similarly, the design or pattern of the tracks are not intended to be limited to those shown herein, but rather are to be chosen by the user for the specific application or use.

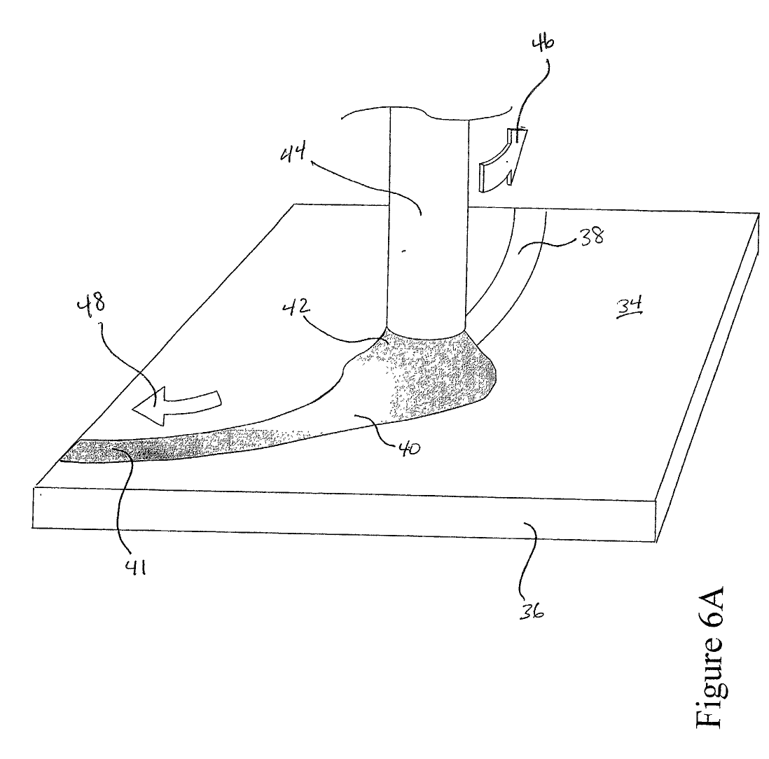

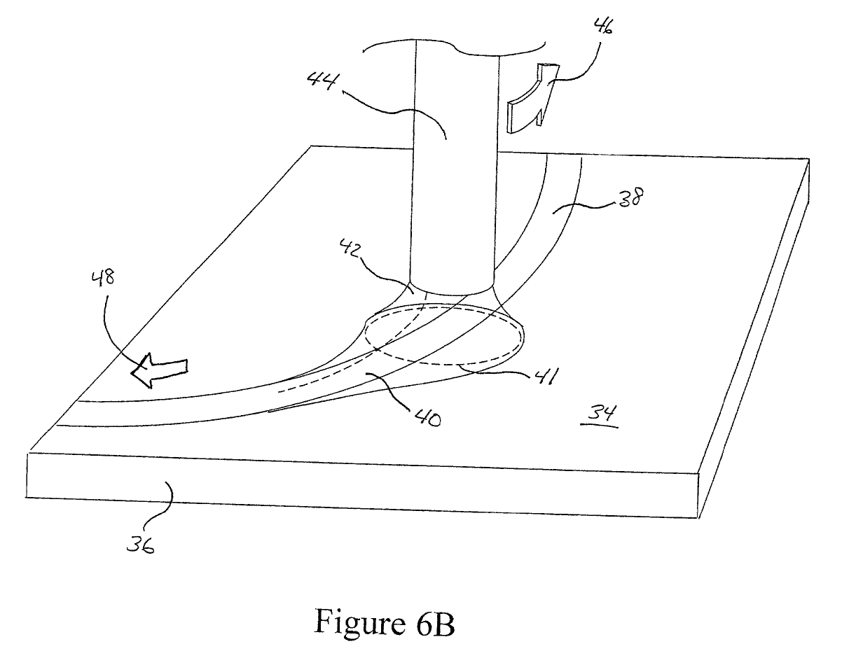

Referring next to FIGS. 6A and 6B, shown are perspective views of a portion of a sample support plate in accordance with the preferred embodiment of the invention. According to the invention, the device used for the continuous deposition of a liquid sample onto a sample support plate preferably comprises sample plate 36 having a predominantly hydrophobic surface 34 with a curved or spiral hydrophilic track 38 patterned thereon, and a means for depositing the liquid sample onto sample support plate 36 along hydrophilic track 38. Such means preferably includes deposition capillary 44 which is used to perform chromatographic deposition of a liquid sample onto plate 36. Other known types of liquid deposition may also be used in accordance with the invention.

The shape of hydrophilic track 38 is created in a reproducible manner so that each plate 36 has a predetermined track position for programmed deposition and analysis. Creation of hydrophilic track 38 is preferably done by treating an electrically conductive plate to create a completely hydrophobic surface on top of a hydrophilic region. Then, hydrophilic track 38 is created by exposing the underlying hydrophilic base material of plate 36 by chemical or mechanical methods. Alternatively, hydrophilic track 38 may be formed by overlaying a hydrophilic material on top of hydrophobic surface 34 of sample plate 36. Other known techniques may also be used.

As further depicted in FIGS. 6A and 6B, liquid sample globule eluate 42 emerges from deposition capillary 44 and is deposited onto hydrophilic track 38 on sample support plate 36. In order for deposition capillary 44 to deposit liquid sample 40 along track 38, deposition capillary 44 moves (as shown by arrow 46) counterclockwise (or clockwise, if desired) in a relative curvilinear plane while sample plate 36 remains stationary. Optionally, sample support plate 36 may be moved (as shown by arrow 48) in a similar manner while deposition capillary 44 is held stationary.

During liquid sample deposition, the column or stream of liquid sample 40 emerges from deposition capillary 44 and produces globule 42, which is then deposited onto sample plate 36 such that it attaches to hydrophilic anchor track 38. As deposition capillary 44 moves relative to the sample support plate 36 (or vice versa), the globule 42 forms an elongated teardrop shape on the sample support plate surface 34 along track 38. As shown in FIG. 6B, globule 42 contacts surface 34 of sample support plate 36 in a generally circular area extending outside of track 38. Thus, as deposition capillary 44 is moved relative to sample support plate 36 (or vice versa), liquid sample 40 is deposited along hydrophilic track 38, and any liquid sample 40 that spreads onto hydrophobic surface 34 of plate 36 contracts toward hydrophilic track 38 as it dries, thereby leaving no sample on hydrophobic surface 34 of plate 36.

According to the preferred embodiment of the invention, deposition capillary 44 moves relative to sample support plate 36 at a rate comparable to the flow rate of liquid sample 40 from deposition capillary 44. The motion of deposition capillary 44 (or sample support plate 36) in this embodiment may be performed using an r-φ (radius-angle) positioner for the circular or curvilinear motion. As depicted in both FIGS. 6A and 6B, deposition capillary 44 preferably moves in a counterclockwise motion. The direction of sample deposition is a matter of design choice which may be dependent upon the particular design or pattern of track 38, the type of deposition device being used, or some other factor.

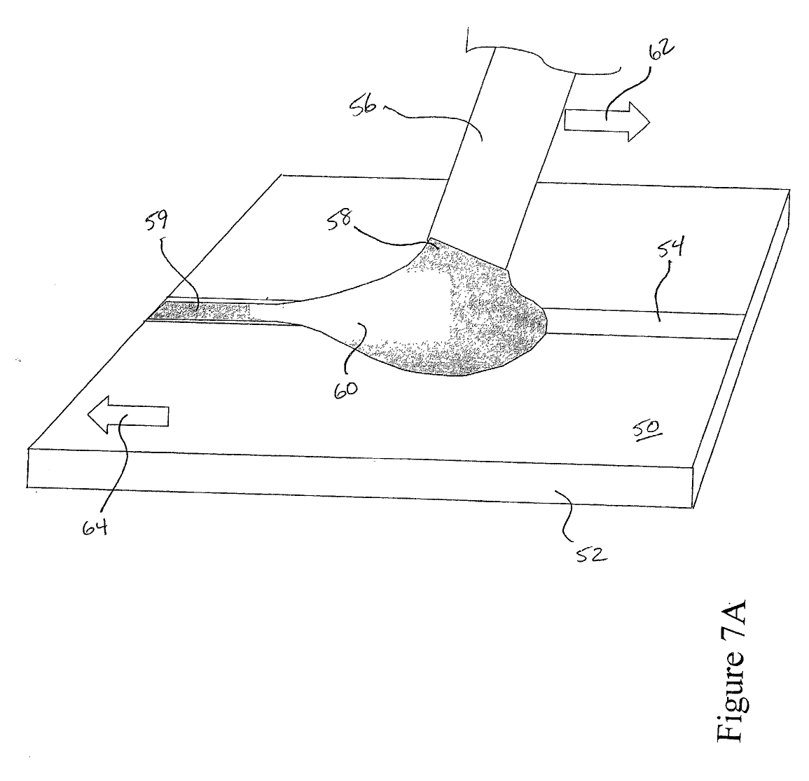

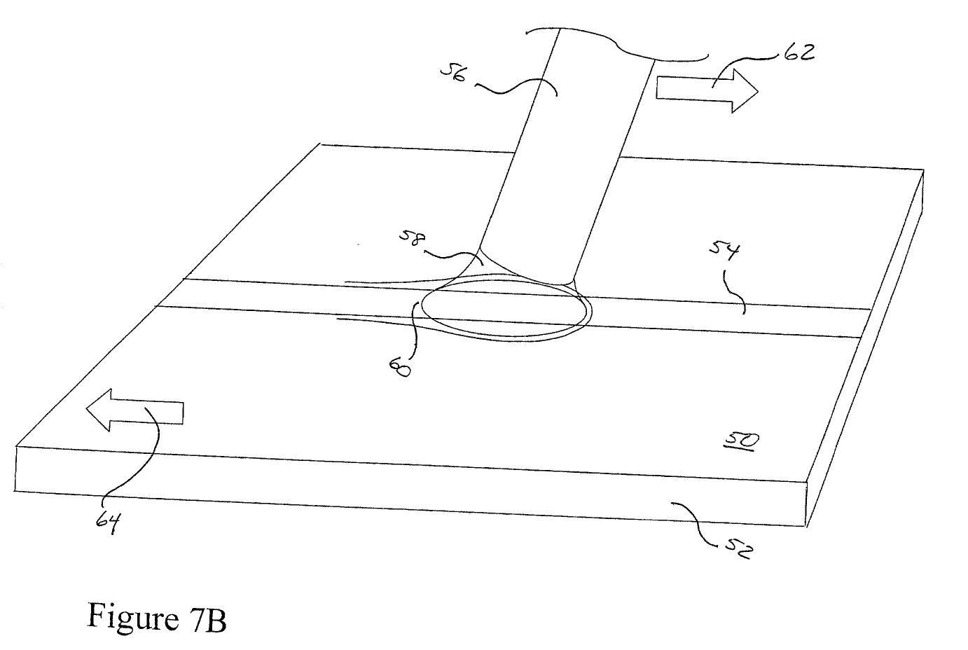

Turning now to FIGS. 7A and 7B, shown are perspective views of a portion of an alternative embodiment of the invention. Specifically, shown is a portion of sample plate 52 that includes a straight portion of folded or convoluted hydrophilic track 54. According to this embodiment of the invention, the device used for the continuous deposition of liquid sample 60 onto sample support plate 52 preferably comprises sample plate 52 having a predominantly hydrophobic surface 50 with a folded or convoluted hydrophilic track 54 patterned thereon (shown more completely in FIG. 5), and a means for depositing the liquid sample onto sample support plate 52 along hydrophilic track 54. Such means preferably includes deposition capillary 56 which is used to perform chromatographic deposition of liquid sample 60 onto plate 52. Other known types of liquid deposition may also be used in accordance with the invention.

As discussed above, the shape of hydrophilic track 54 is determined such that it is reproducible so that each plate 52 has a predetermined track position for programmed deposition and analysis. Hydrophilic track 54 is preferably formed by treating an electrically conductive plate to create a completely hydrophobic surface on top of an underlying hydrophilic region. Then, a narrow track of the hydrophilic region exposed by chemical or mechanical methods. Alternatively, hydrophilic track 54 may be formed by overlaying a hydrophilic material on top of hydrophobic surface 50 of sample plate 52. Other known techniques may also be used.

As further shown in FIGS. 7A and 7B, liquid sample 60 globule eluate 58 emerges from deposition capillary 56 and is deposited onto a straight portion of track 54 on sample support plate 52. Deposition of the sample onto curved portions of the hydrophilic track is discuss herein above with respect to FIGS. 6A and 6B. For the continuous deposition of the liquid sample onto the straight portions of the hydrophilic track 54, lateral movement of either deposition capillary 56 or sample support plate 52 may be used. During liquid sample deposition, the column or stream of liquid sample 60 emerges from deposition capillary 56 and produces eluate globule 58, which is then deposited onto sample plate 52 such that it attaches to hydrophilic anchor track 54. As deposition capillary 56 moves relative to sample support plate 52 (or vice versa), globule 58 forms an elongated teardrop shape on the sample support plate surface 50 and along track 54. As shown specifically in FIG. 7B, globule 58 contacts surface 50 of sample support plate 52 in a generally circular area extending outside of track 54. Thus, as deposition capillary 56 is moved relative to sample support plate 52 (or vice versa), liquid sample 60 is deposited along hydrophilic track 54, and any liquid sample 60 that spreads onto hydrophobic surface 50 of plate 52 contracts toward hydrophilic track 54 as it dries, thereby leaving no sample on hydrophobic surface 50 of plate 52.

According to the preferred embodiment, deposition capillary 56 is moved relative to sample support plate 52 at a rate comparable to the flow rate of liquid sample 60 from deposition capillary 56. The motion of deposition capillary 56 (or sample support plate 52) may be performed using a planar positioner, an x-y positioner for Cartesian motion, and an r-φ (radius-angle) positioner for any curved or circular motion. As depicted in FIGS. 7A and 7B, deposition capillary 56 preferably moves to the right (as shown by arrow 62) in a relative linear plane with respect to a stationary sample plate 52. Of course, the direction of sample deposition is a matter of design choice which may be dependent upon any of a number of factors, including but not limited to the design or pattern of track 54, the automated system being used. Alternatively, deposition capillary 56 may be held stationary while sample plate 52 is moved to the left (as shown by arrow 64) in a relative linear plane with respect to the stationary deposition capillary 56. In yet another alternative, a combination of relative movement of both deposition capillary 56 and sample plate 52 may be used during the deposition process.

The above examples are shown for demonstration only, and are not intended to be all encompassing. In practice, there are an infinite number of ways sample support plate 52 and deposition capillary 56 may move in relation to each other, primarily dependent upon the design of the hydrophilic track 54. During the subsequent analysis of the deposited sample, because the sample is precisely located on a predefined anchor track 54, the laser beam can be accurately directed to always hit a portion of the deposited sample.

Referring generally to FIGS. 6A-B and 7A-B, globule 42, 58 will maintain a certain dimension from the addition of fresh liquid eluate at one end of globule 42, 58 that counteracts the evaporation of the liquid over the surface of globule 42, 58. At the end of globule 42, 58 furthest from deposition capillary 44, 56, the continual evaporation process will cause the liquid eluate to contract to hydrophilic anchor track 38, 54. As globule 42, 58 rapidly shrinks, the rate of contraction towards track 38, 54 exceeds the rate of dispersion of sample components through the liquid volume and preserves the fidelity of the chromatographic separation. The narrow, concentrated track of liquid 41, 59 attached to hydrophilic anchor track 38, 54 continues to evaporate until only the MALDI matrix and sample remains. The result of the process is a narrow band of solvent-free MALDI matrix and sample deposited from a continuous liquid eluate. This narrow band 41, 59 has a well-defined position along hydrophilic track 38, 54 and the sample has been concentrated into the track region from a larger liquid volume.

Certain considerations have to be made for a continuous deposition and concentration of liquid sample 40, 60 on sample plate 36, 52 with predefined hydrophilic anchor track 38, 54, providing that a part of the deposited liquid is overlapping with hydrophilic anchor track 38, 54 during the deposition. As discussed previously, deposited liquid globule 42, 58 must have the following size restrictions: (1) globule 42, 58 should not have a radius exceeding the distance between adjacent tracks to prevent the contamination of the adjacent track with the sample being deposited, (2) globule 42, 58 should not be so large that it spreads along the length of hydrophilic track 38, 54 due to the attraction of the liquid to the hydrophilic surface, and (3) globule 42, 58 should not be so large that it causes different components from the sample, separated by the chromatographic separation, to become mixed in the liquid volume of globule 42, 58.

Accordingly, globule 42, 58 will shrink by evaporation and concentration of the liquid sample toward hydrophilic track 38, 54 at a rate that matches or exceeds the flow rate of liquid sample 40, 60 into globule 42, 58 from deposition capillary 44, 56. As stated above, there are three important parameters to ensure the rapid shrinkage of globule 42, 58: (1) the liquid flow rate out of deposition capillary 44, 56 (which is set by the device (syringe pump, HPLC, CE, etc.) that is providing liquid sample 40, 60); (2) the speed of motion of deposition capillary 44, 56 relative to sample support plate 36, 52 (which must be adjusted to ensure that for given conditions of solvents, flow rates, temperature and pressure, liquid globule 42, 58 has a constant dimension and evaporates in a short time); and (3) the shrinking rate of the deposit while the solvent evaporates (which is a function of the volatility of the solvent (or solvent mixture) at the temperature (especially the temperature of the target surface) and pressure in the vicinity of the deposition area, which can be controlled or set to a certain value).

In accordance with the invention, a MALDI matrix dissolved in a liquid solution may be deposited on hydrophilic anchor track 38, 54 from a separate narrow diameter hollow tube or together with the sample through deposition capillary 44, 56. The MALDI matrix may be separately deposited and desolvated at some time interval prior to the addition of the samples to tracks 38, 54. The MALDI matrix may be co-added to the sample solution by pumping a solution of matrix from a separate pump through a mixing-T prior to deposition capillary 44, 56 or to a second deposition capillary that runs immediately before or behind deposition capillary 44, 56.

The samples deposited on sample support plate 36, 52 are then analyzed by, for example, MALDI time-of-flight (TOF) mass spectrometry. For laser desorption, the laser beam is focused onto the sample and matrix that have been concentrated onto the predefined position on hydrophilic anchor track 38, 54. In order to analyze the complete sample deposited on plate 36, 52, the sample has to be frequently or continuously desorbed along track 38, 54. Desorption is accomplished by a relative motion of sample support plate 36, 52 and the repetitive firing of the focused laser beam. As previously described, the motion of sample support plate 36, 52 is performed using a planar positioner (an x-y positioner for Cartesian motion or an r-φ positioner for circular motion). Because the sample is precisely located on a predefined anchor track 38, 54, the laser beam can be accurately directed to always hit the sample.

The repetition rate of the laser shots and the speed of motion of sample support plate 36, 52 are controlled so that the desired number of mass analysis measurements is recorded along the length of track 38, 54. By monitoring the ions resulting from each acquired measurement, the speed of motion of sample support plate 36, 52 may be altered with a feedback mechanism.

Preferably, the shape of the continuous hydrophilic anchor track 38, 54 is created in a reproducible way so that each plate 36, 52 has a predetermined track position for programmed deposition and analysis, for example, as shown in FIGS. 4 and 5. An electrically conductive plate is treated to create a hydrophobic surface, with a hydrophilic region created by exposing the underlying hydrophilic base material of the sample support plate by chemical or mechanical methods or by overlaying a hydrophilic region on the hydrophobic surface. The shape of the continuous track 38, 54 is preferably designed to make the most use of the area on the surface of the sample support plate.

While the present invention has been described with reference to one or more preferred embodiments, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A method of preparing samples for matrix-assisted laser desorption/ionization (MALDI) mass spectrometric analysis, said method comprising the steps of:
providing an electrically conductive sample support plate having a hydrophobic surface with at least one continuous hydrophilic track;
depositing a liquid sample onto said sample support plate concentrated along said hydrophilic track using a deposition capillary; and
drying said liquid sample onto said sample support plate such that a continuous track of said dried sample from said liquid sample is obtained.

2. A method according to claim 1, wherein a distance between adjacent portions of said continuous track is greater than the diameter of a globule of said liquid sample being deposited on said sample support plate.

3. A method according to claim 1, wherein said deposition capillary moves along said continuous track during said depositing.

4. A method according to claim 1, wherein said sample support plate moves during said depositing such that said continuous track follows said deposition capillary, while said deposition capillary is in a fixed position.

5. A method according to claim 1, wherein said deposition capillary comprises a matrix solution deposition capillary and a sample solution deposition capillary.

6. A method according to claim 5, wherein a matrix solution is first deposited onto said sample support plate from said matrix solution deposition capillary and allowed to evaporate, and wherein after said evaporation said sample solution is continuously deposited from said deposition capillary.

7. A method according to claim 1, wherein a matrix solution and said sample solution are continuously mixed in said deposition capillary.

8. A method according to claim 1, wherein said liquid sample to be deposited onto said continuous track is an eluate from the group consisting of a capillary electrophoretic separation and a liquid chromatographic separation.

9. A method according to claim 1, wherein said sample support plate comprises a plurality of said continuous hydrophilic tracks.

10. A method according to claim 9, wherein a plurality of said samples are deposited onto said sample support plate, each said sample being deposited onto a separate one of said hydrophilic tracks.

11. A method according to claim 1, wherein said electrically conductive sample support plate is formed by overlaying a track of hydrophilic material on top of said hydrophobic surface of said sample support plate.

12. A method according to claim 1, wherein said electrically conductive sample support plate is formed by depositing a layer of hydrophilic material on said sample support plate, depositing a layer of hydrophobic material on top of said hydrophilic material, and chemically exposing said hydrophilic material in a desired pattern.

13. A method according to claim 1, wherein a pattern of said hydrophilic track is selected from the group consisting of spiral, folded, and convoluted.

14. A method of matrix-assisted laser desorption/ionization (MALDI) mass spectrometric analysis, said method comprising the steps of:
providing an electrically conductive sample support plate having a hydrophobic surface with at least one continuous hydrophilic track;
depositing a liquid sample onto said sample support plate concentrated along said hydrophilic track using a deposition capillary;
drying said liquid sample onto said sample support plate such that a continuous track of said dried sample from said liquid sample is obtained; and
exposing said sample on said hydrophilic track to a focused laser beam in order to perform laser desorption ionization mass spectrometry.

15. A method according to claim 14, wherein said sample includes a matrix material to perform matrix-assisted laser desorption ionization mass spectrometry.

16. A method according to claim 15, wherein said laser desorption ionization mass spectrometry is atmospheric pressure matrix-assisted laser desorption ionization mass spectrometry.

17. A method according to claim 14, wherein said sample is laser desorbed along said hydrophilic anchor track by moving said focused laser beam along said hydrophilic track.

18. A method according to claim 14, wherein said sample is laser desorbed along said hydrophilic anchor track by moving said sample support plate such that said hydrophilic track moves along the path of said focused laser beam.

19. A method according to claim 14, wherein said depositing and said exposing occur simultaneously on different portions of said hydrophilic track.

20. A method according to claim 19, wherein a first sample is undergoing said depositing and a second sample is undergoing said exposing.

21. A method according to claim 14, wherein said focused laser beam moves along said hydrophilic track for said laser desorption ionization at a speed that is varied according to a measured intensity of any generated ions.

22. A method according to claim 14, wherein pre-accumulation of ions generated by said laser desorption from said continuous hydrophilic track from multiple laser shots occurs in a pre-accumulation device.

23. A method according to claim 22, wherein said pre-accumulation device is selected from the group consisting of a multipole ion guide, a Paul ion trap, and a Penning (ICR) ion trap.

24. A method according to claim 14, wherein said focused laser beam moves along said hydrophilie track for said laser desorption ionization at a speed that is varied so time is allowed for obtaining multiple mass spectra for said sample before said track is repositioned to a region where said sample is no longer detected.

25. A sample support plate for laser desorption/ionization mass spectrometric analysis, said sample support plate comprising an electrically conductive base having a surface comprising both hydrophobic and hydrophilic regions, wherein said hydrophilic region is at least one continuous track within said hydrophobic region.

26. A sample support plate according to claim 25, wherein said continuous track of hydrophilic material is formed by depositing a layer of hydrophilic material on said base, depositing a layer of hydrophobic material on top of said hydrophilic material, and chemically exposing said hydrophilic material in said continuous track.

27. A sample support plate according to claim 25, wherein said continuous track of hydrophilic material is formed by depositing a layer of said hydrophobic material onto said base and overlaying said continuous track of hydrophilic material on top of said hydrophobic surface of said base.

28. A sample support plate according to claim 25, wherein said continuous track of hydrophilic material is in a form selected from the group consisting of a spiral pattern, a folded pattern, and a convoluted pattern.
